(19) United States
(12) Patent Application Publication
(10) Pub. No.: US 2006/0293039 A1
(43) Pub. Date: Dec. 28, 2006

(54) Method and system for transferring messages to a mobile station according to specific parameters

(76) Inventor: Ruben E. Maislos, Or-Yehuda (IL)

Correspondence Address: PEARL COHEN ZEDEK LATZER, LLP, 1500 BROADWAY, 12TH FLOOR, NEW YORK, NY, 10036, US

(21) Appl. No.: 11/166,143

(22) Filed: Jun. 27, 2005

(51) Int. Cl. H04M 3/00

(52) U.S. Cl. 455/418

(57) ABSTRACT

A method and system may allow for storing a mobile station user's parameters at a center such as a wireless communication system database and transferring messages to a mobile station according to the user's parameters. The user's parameters may include for example an indication of a user's language, and messages may be transferred to a mobile station according to the parameters

### BACKGROUND OF THE INVENTION

Message services such as, for example short message service (“SMS”), wireless application protocol (“WAP”), or other services, are common services that may enable transferring of for example alphanumeric or other messages over wireless communication systems, for example, cellular communication systems. Message services enable, for example, transmission of alphanumeric messages between plurality of message entities, for example, mobile stations, and possibly external systems such as, for example, other mobile stations, electronic mail, voice-mail systems, paging networks and network operators.

When a mobile station user receives a message while in his local network area or home country, the message is usually displayed in the local language. When a mobile station is roaming, for example, outside a home service area or to a foreign country, the local network does not know of the local language, and may send messages according to a different language which the user and/or the mobile station may not understand. Other user configurations may not be supported by a local network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic block diagram of a portion of a message service system according to an embodiment of the present invention;

FIG. 2 is a schematic block diagram of a mobile station according to an embodiment of the present invention;

FIG. 3 is a schematic block diagram of a switching center according to an embodiment of the present invention;

FIG. 4 is a flowchart of a method of transferring user's parameters from a mobile station to a switching center according to embodiments of the present invention.

FIG. 5 is a flowchart of a method of transferring user's parameters from a mobile station to a switching center according to embodiments of the present invention; and

FIG. 6 is a flowchart of a method for transferring messages according to user's parameters from a switching center to a mobile station according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like. For example, “plurality of mobile stations” describes two or more mobile stations.

It should be understood that embodiments of the present invention may be used in a variety of applications. Although the present invention is not limited in this respect, the circuits and techniques disclosed herein may be used in many apparatuses such as mobile stations and switching centers of a radiotelephone communication systems, for example a cellular communication system. In other embodiments, other devices and systems may include embodiments of the invention. For example, pagers, personal digital assistants (PDAs) or instant messaginig (IM) systems may use or embody embodiment of the invention.

Types of cellular radiotelephone systems intended to be within the scope of the present invention include, although are not limited to, Code Division Multiple Access (CDMA) and wideband CDMA (WCDMA) cellular radiotelephone portable devices for transmitting and receiving spread spectrum signals, Global System for Mobile communication (GSM) cellular radiotelephones, Time Division Multiple Access (TDMA), GPRS, Extended GPRS, and the like.

Some embodiments of the invention may be implemented, for example, using a machine-readable medium or article which may store an instruction or a set of instructions that, if executed by a machine (for example, by data centers, micro-cells and/or cellphones of wireless communication system, and/or by other suitable machines), cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Video Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

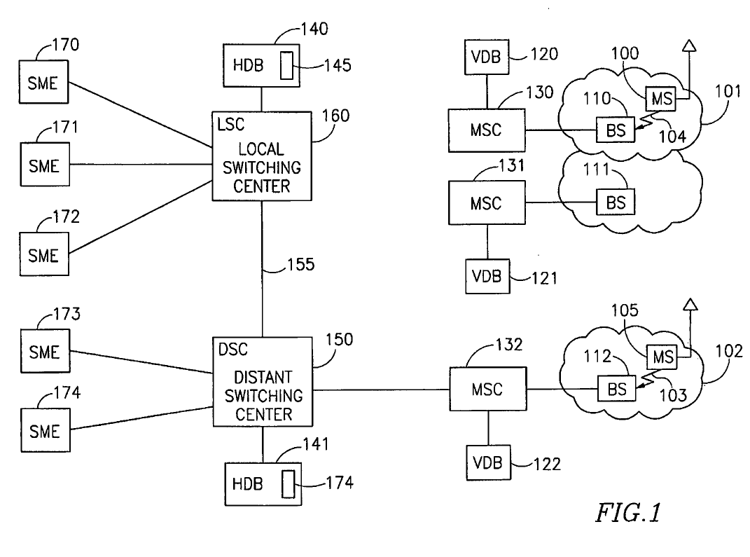

Turning to FIG. 1, a schematic block diagram of a portion of a wireless service communication system according to an illustrative embodiment of the invention is shown. Although the scope of the present invention is not limited in this respect, wireless service communication system 190 may include a set of short messages entities (“SME”) 170, 171, 172, 173, and 174, which may be or include, for example, web based messaging devices, voice mail systems, electronic mail services, PDAs, PCs, mobile stations or any other suitable short message entity, that may be located in, for example, a fixed communication network or a wireless communication network. In some embodiments of the invention, SMEs 170-174 may be operably coupled to a switching center (“SC”). For example, SMEs 170, 171 and 172 may be connected to a local switching center (“LSC”) 160 and SMEs 173 and 174 may be connected to a distant switching center (“DSC”) 150. When used herein, local and distant are relative terms. For example, DSC 150 may be “distant” in some sense to a service provider associated with LSC 160. In addition wireless service communication system 190 may include a set of mobile switching centers (“MSC”) 130, 131, and 132 which may perform any switching functions required for transferring messages between mobile stations (“MS”) 100 and 105 through base stations (“BS”) 110, 111 and 112 using air links 103 and 104. The wireless communication system 192 may further include areas or cells 01 and 102. In one example, a mobile phone may be associated with a subscription or an account with a service provider controlling LSC 160, and DSC 150 may be controlled by a different entity. For example, DSC 150 may be in a different country or legion than LSC 160. In other embodiments, LSC 160 and DSC 160 may overlap regionally and/or be associated with the same entity.

In some embodiments of the present invention the switching centers 150 and 160 may act as a store and forward system for short messages or other messages, which may include, for example, advertisements, promotional messages, system notifications or personal messages. For example, LSC 160 may receive a message from SME 170 and forward this message to a mobile station 100. In some embodiments of the present invention, a switching center (SC) may act also as a network element for contacting other networks or multiple network elements, for example, the home databases (“HDB”) 140 and 141, the mobile switching centers 130, 131 and 132 and the like. In some embodiments of the invention, the HDBs 140 and 141 may be used for storing information on, for example the subscription profile of a mobile station, routing information for a subscriber, or any other suitable information. The HDBs 140 and 141 may act as the main databases of the SC, but need not be, and other or additional databases may be used. HDB 141 may be, may include, or may be included in, for example, a home location register (“HLR”) or any other data storage unit. In some embodiments of the present invention, the HDBs 140 and 141 may be located inside the relevant SC while in other embodiments these units may be located outside the SC. For example, HDB 140 may be located inside LSC 160 or may be located outside LSC 160 and connected to LSC 160, as shown in FIG. 1.

In some embodiments of the present invention, the mobile switching centers (“MSC”) 130, 131 and 132 may perform any switching functions required for transferring messages between mobile stations or between mobile station and a fixed network. For example, MSC 130 may transfer a message received from SME 170 to mobile station 100 through base station 110 Although the scope of the present invention is not limited in this respect, cellular communication system 190 may include mobile stations (“MS”) 100, 105 and 106, base stations (“BS”) 110, 111 and 112. The MSC 130 may be connected to a dedicated database, for example visitor database (“VDB”) 120, 121 and 122, which may be located in the MSC or outside the MSC. In some embodiments of the present invention the VDB 120 may act as the MSC 130 database and may be used for storing temporary information about MSs homed in one SC. For example, the home SC may be LSC 160, and when a MS is roaming into another SC, for example, VDB 120 may hold information such as, for example, a MS identification and the cell where a MS is currently situated Using the information from a VDB, a MSC may be able to transfer messages to a specific MS through a corresponding BS, for example, MSC 132 may transfer a message to roaming MS 105 through BS 112 and air link 103. VDB 120 may be, may include, or may be included in, for example, a visitor location register (“VLR”) or any other data storage unit. Roaming may include, for example, moving from an area served by a the cellular service provider with which the MS is associated to an area not served by that cellular service provider, or served by a different section or part of that service provider. For example, roaming may occur when a MS user, for example, MS 105, moves from their home city. For example, an MS may move from cell 101, in which it may receive messages through SC 160, to a separate region within a country, or to a different country MS 105 may move to cell 102, where it may receive messages through SC 150.

According to an illustrative embodiment of the present invention, MS 100 may receive a message from any SME 170, 171 or 172, for example, the Internet, electronic mail, a network operator, MS, or any other message entity. A message may include for example, personal messages, promotions system messages, and may include text and/or other media, such as graphics or pictures MS 100's subscriber may define the MS parameters, for example, indication of a user's language, for example, a preferred language, to be language A, a default language to be language B, and this information may be transferred to the MS's LSC 160 and may be stored in a suitable database, for example HDB 140. Methods of defining parameters other then via a MS may be use, for example, via a telephone operator. Parameters such as a default language or other default parameters need not be entered by a user, but may be set by, for example a cellular operator. LSC 160 may transfer messages to MS 100 according to, controlled by, or as defined by the user's defined parameters. For example, a message may be transferred according to a language parameter and displayed on MS 100's display screen in language A fonts and characters. If no preferred language is created or known for a user, the message may be transferred according to the language parameter for default language B, and displayed on MS 100's display screen in language B fonts and characters. Instructions for transferring messages according to user's parameters according to one embodiment of the invention may be, for example, stored in a storage medium; the instructions may be performed by a processor. In some embodiments of the invention the user's parameters may be transferred to a dedicated database for example, HDB 140, HLR or any other suitable database, whenever the subscriber may change the parameters. Although the scope of the present invention is not limited in this respect, MS 105 may include a set of fonts, formatting and display parameters and may use any of them when displaying a received message. In addition SC 150 and 160 may include a list of each user's parameters allowed, and also may store the actual fonts, for example, a set of fonts, a set of fonts size, and may select the appropriate parameters from the lists according to the user's parameters.

Although the scope of the present invention is not limited in this respect, a user may define MS 100's parameters, for example, indication of a user's preferred language, default language, preferred formatting, for example fonts, display parameters, for example, number of displayed lines, font size, preferred dialects and special display for messages received from a certain source. In some embodiments of the present invention parameters may be stored in a dedicated block inside appropriate databases, for example, data block 145 inside HDB 140 and block 146 inside HDB 141.

MS 105 may in some cases move or roam to area 102 from area 101. Areas 101 and 102 may or may not be contiguous, and may be, for example, different regions, having different service coverages, within the same country; for example areas 101 and 102 may be served by different service providers. Areas 101 and 102 may be, for example, in different countries, and may be served by different service providers, but may be served by the same service providers having different systems for different regions or countries Information for MS 105 may be located in HDB 140 as being coupled, for example, may be located in or connected to LSC 160, which in this illustrative embodiment is considered the LSC of MS 105. SCs may include instructions and processing capability to transfer user parameters between SCs when needed. Data block 145 of HDB 140 may store information such as for example the subscriber's parameters, for example, language A as the preferred language and language B as the default language. Other parameters may be stored, such as for example, preferred font, font size, number of displayed lines and the like. While roaming in area 102, MS 105 may receive messages according to the specific user's parameters as saved in parameters data block 145 of HDB 140. For example, upon learning of the presence in area 102 of a MS associated with LSC 160, DSC 150 may submit a request for the transfer of user's information from LSC 160. LSC 160 may send the required information to DSC 150, for example, by link 155, which may be a communication cable or medium, which may save the parameters in, for example, parameters block 146 of VDB 141 and send the message according to the retrieved parameters, for example, according to user's language A or according to user's default language B, in case language A is not supported by DSC 150, through MSC 132 and BS 112 to MS 105. Alternately, the retrieved parameters may be stored in a dedicated block (not shown) in VDB 122 and may be used for future service of MS 105. Alternatively or additionally, MS 105 may transfer user's parameters stored in a dedicated user's parameters list in the MS to VDB 122, and DSC 150 may transfer messages to MS 105 according to user's parameters stored in VDB 122. Alternatively or additionally, HDB 141 may save the parameters retrieved from VDB 122 or LSC 160.

Although the scope of the present invention is not limited in this respect, SC 150 and 160 may include a list of each user's parameters allowed, and also may store the actual fonts, for example, a set of fonts, a set of fonts size, and may select the appropriate parameters from the lists according to the user's parameters stored in, for example, HDB 140, and 141, VDB 120, 121 and 122. SC 150 and 160 may send a message according to user's parameters and a MS may receive the message by air link 103, may demodulate the signals and may display the message in the convenient way for MS 105 user to read.

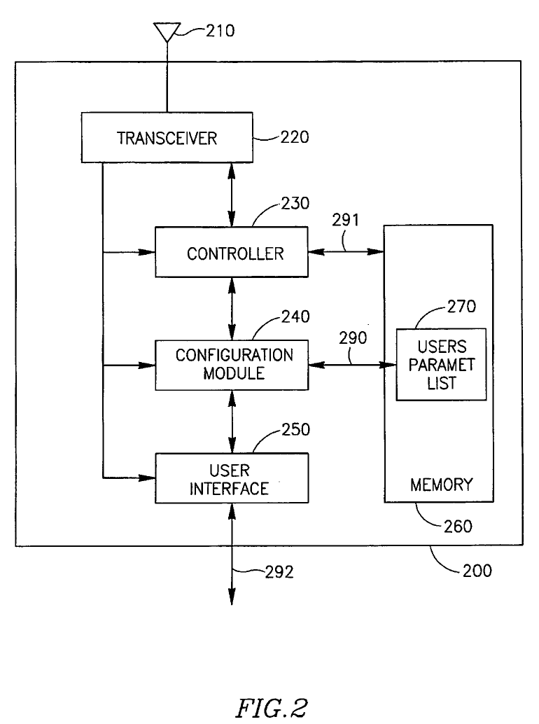

In FIG. 2, a block diagram of a MS 200 according to an illustrative embodiment of the present invention is shown. Although the scope of the present invention is not limited in this respect, MS 200 may include an antenna 210, a transceiver 220, a controller 230, a configuration module 240, a user interface block 250, a memory 260, a user interface channel 292, and a user parameters list 270. User parameters list 270 may include, for example, preferred language, default language, preferred font, font size, number of displayed lines and the like. In operation, MS 200 may be configured by using user interface channel 292 and user interface block 250, to receive and send messages according to user preferences. User interface block 250 and user interface channel 292 may include, for example, a display screen, keyboard and the like. Accordingly, configuration module 240 may store the user's parameters which may be for example inserted through user interface channel 292 and user interface block 250, sent from a central office, or entered in other manners, in a user's parameters list 270 that may be located in memory 260. Although the scope of the present invention is not limited in this respect, types of memory that may be used with embodiments of the present invention may include, for example, a shift register, a flip flop, a Flash memory, a random access memory (RAM), dynamic RAM (DRAM), static RAM (SRAM) and the like. In some embodiment the memory may be located in a removable card or removable chip, for example a SIM card.

Although the scope of the present invention is not limited in this respect, the user may configure MS 200 to receive a message coded in certain language according to a user's preferred language; other user parameters may be configured. Other ways of configuring MS 200 may be used. Configuration module 240 may store information regarding a language in user parameters list 270. Accordingly, in some embodiments of the invention, controller 230 may transfer the user's parameters, which may be retrieved from, for example, user's parameters list 270 or configuration module 240, to any suitable database, for example, the LSC 160 database HDB 140 or an HLR through transceiver 220 and antenna 210. Furthermore, controller 230 may transfer the user's parameter list 270 through transceiver 220 and antenna 210, whenever conditions may be changed. For example, when MS 200 may be roaming, MS 200's user parameters may be changed; retransferring of user's parameters may be performed in other situations. In another embodiment of the present invention controller 230 may transfer portions of the user's parameters list 270, for example only specific parameters from the list. User parameters need not be stored in a mobile station; For example user parameters may be only stored at an SC.

Although the scope of the present invention is not limited in this respect, MS 200 may receive over an air link, for example air link 104, messages coded in a certain language, or messages that are formatted to and in a certain language, according to the stored user's parameters, for example, parameters data block 145 of HDB 140. Antenna 210, for example a dipole antenna, may receive modulated signals that may carry the message. Transceiver 220 may demodulate the modulated signals and may provide data that includes text information to user interface 250. Other configurations for a mobile station may be used. A mobile station may include, for example pagers, personal digital assistants (PDAs), PCs and the like.

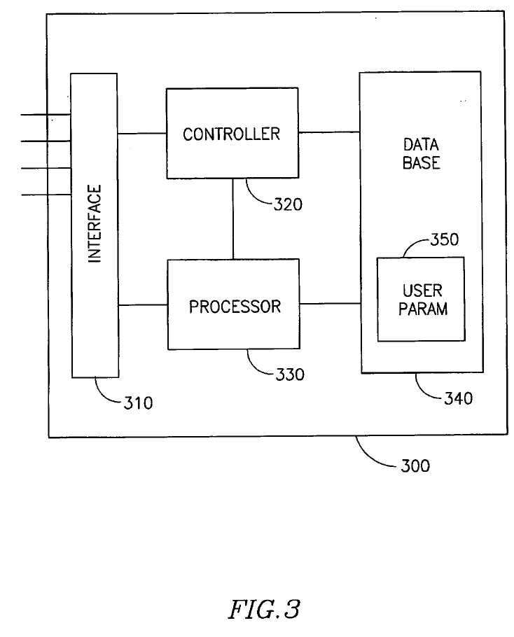

In FIG. 3, a block diagram of a switching center (SC) according to embodiments of the present invention is shown. Although the scope of the present invention is not limited in this respect, SC 300 may include an interface unit 310 which may include fixed network interface and mobile network interface, for example, TCP/IP, ISDN, SS7 and the like. In addition, SC 300 may include controller 320, a processor 330 and a database 340. Other configurations for an SC may be used.

In operation, interface 310 may be used to receive and transmit signals that may carry text message or other (e.g. video) information, for example, message sending time, group of destinations and the like and a message content. Furthermore, interface 310 may be used to receive user's parameters from, for example, a MS subscriber, or another SC. Incoming data may be transferred to processor 330 for further decoding processes. Controller 320 may be used to transfer required information from processor 330 to database 340 for storing, for example, messages to be sent, routing information, user's parameters and the like. In addition, controller 320 may be used for retrieving data stored in database and transfer it to interface 310 through processor 330, for example, transfer the user's language as was stored in database to a distant switching center. Database 340 may be operably coupled to a processor 330 and to controller 320 and may include user's information in a dedicated user's parameters list 350, including preferred user's parameters. Database 340 may be located inside switching center 300, or may be located outside switching center 300. Other methods of operation of an SC may be used.

Although the scope of the present invention is not limited in this respect, switching center 300 may receive a message in order to forward this message to a MS. In this scenario processor 330 may search user's parameters list 350 of database 340 for stored user's parameters of the specific MS. Processor 330 may send the message to the MS according to the user's parameters as may be stored in user's parameters list 350 of database 340. In some embodiment of the present invention, switching center 300, may have available different language formats, fonts and messages in different languages. For example, for certain, but not necessarily all, messages, multiple language formats and multiple language messages may be available. Switching center 300 may choose the appropriate message and format for sending according to the user's parameters 350 in database 340 and may send the message included in a certain language through inter face 310 to MS 105.

Although the scope of the present invention is not limited in this respect, database 340 may include or be embodied in a storage medium (not shown) to store the user's parameters 350. In embodiments of the present invention, the storage medium may include for example, a hard drive, recordable digital video disk (DVD), recordable compact disk, and the like. Furthermore, the user's parameters may be arranged according to a user list wherein a user name or ID may be an entry and/or an address to the user's parameters.

Although the scope of the present invention is not limited in this respect, a request may be received from a DSC to transfer user's parameters of a local user who may be roaming at a certain moment to the DSC area. In this scenario controller 320, may receive this request through interface 310 and order processor 330 to retrieve the information from user's parameters list 350 and transfer the required parameters through interface 310 to the DSC. Furthermore, the roaming MS's user may receive from the DSC messages coded in a certain language according to his preferred parameters as were stored in his home switching center, for example, LSC 160.

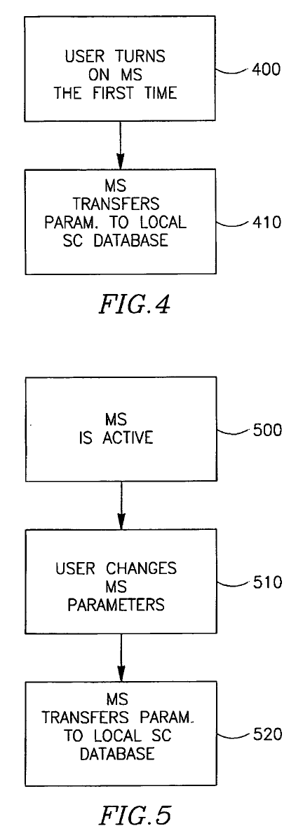

Turning to FIG. 4, a flowchart of a method of transferring user's parameters from a MS to a switching center database according to illustrative embodiments of the present invention is shown. Although the scope of the present invention is not limited to this respect, according to some illustrative embodiments of the invention, a MS, for example MS 105, may transfer user's information, for example, a user's preferred language, a user default language and the like, to a switching center database or other central database. According to this illustrative method, a MS may transfer the user's parameters when it is first turned on, powered up or otherwise active, or enters the area of a switching center.

In block 400 a MS may become active in a certain area for the first time. For example, a user may turn on the MS, or the MS may move from one area to the area relevant to a certain switching center, or a SIM card may be used for the first time in a different area. Although the scope of the present invention is not limited to this respect, according to some illustrative embodiments of the invention, a MS may become active for the first time in a certain area, which may be considered as the MS local switching center area.

In block 410, the MS may transfer the user's parameters to a LSC. For example, transmission of signals by MS 100 to a LSC database HDB 140 may be accomplished through air link 104, BS 110, and MSC 130. In some embodiments of the invention, the parameters that may be stored in a LSC database, for example, HDB 140, an HLR or any other database, may be used by a switching center that may be a local SC or a distant SC to transfer messages to MS 100 according to user's parameters.

Turning to FIG. 5, a flowchart of a method of transferring user's parameters from a mobile station to a local switching center database according to illustrative embodiments of the present invention is shown. Although the scope of the present invention is not limited to this respect, according to some illustrative embodiments of the invention, a MS, for example MS 105, may transfer user's information, for example, user's preferred language, user default language and the like, to a local switching center database. According to this illustrative method, a MS may transfer the user's parameters whenever the parameters of a MS need to be or have been changed.

In block 500 a MS may be active in a certain area. For example, a user may have powered up the MS while in a certain area, or entered a certain area, and the user's parameters may have been transferred to the LSC database.

In block 510 a user may decide to change his preferred parameters as may have been already stored in LSC database. For example, a user may change his preferable language, fonts or any other parameter by using a MS user interface, for example, a keyboard and a display screen. Although the scope of the present invention is not limited to this respect, according to some illustrative embodiments of the invention, the new parameters may be transferred to a dedicated storage unit inside the MS or may be transferred directly to a LSC database or a MSC database as illustrated in block 520.

In block 520 the MS may transfer the user's parameters to a LSC database. For example, transmission of signals by MS 100 to LSC database HDB 140 may be done through air link 104, BS 110, and MSC 130. In some embodiments of the invention, the parameters that may be stored in LSC database, for example, HDB 140, an HLR or any other database, may be used by a switching center that may be a local SC or a distant SC to transfer messages to MS 100 according to user's parameters.

The user may change MS 100 parameters while roaming in a distant area, for example area 102. In this scenario, MS may transfer user's parameters to a local MSC database, for example, VDB 122, VLR or other temporary database that may serve roaming MSs, the user's parameters may be taken into consideration while a DSC, for example, DSC 150 may wish to transfer a message to MS 100. Furthermore, in some embodiments of the present invention the user's parameters may be transferred to the LSC database HDB 140 through DSC 150, in order to update the user's parameters stored in LSC database HDB 140. In some embodiment of the present invention a user may change MS 100 parameters by using another entity or service, for example, the Internet or by contacting a customer services representative.

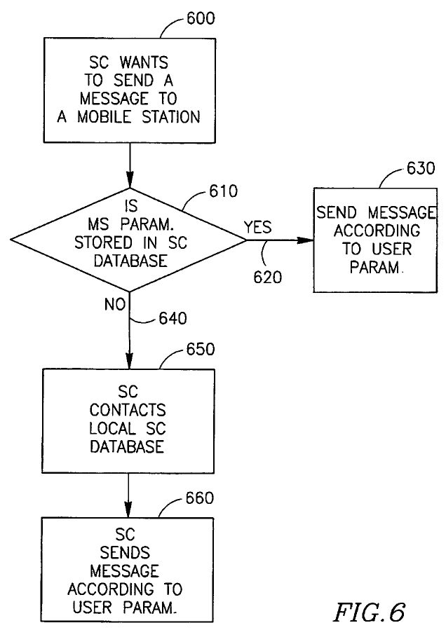

Turning to FIG. 6, a flowchart of a method for transferring messages according to user's parameters from a switching center to a mobile station according to illustrative embodiments of the present invention is shown.

In block 600 a switching center may wish to send a message to a MS user For example, the network or the carrier may wish to send a promotion to a MS user through the switching center, or a MS user may wish to send a short message to another MS user and this may for example, be performed by a switching center.

In block 610 a switching center may check whether the MS user's parameters of the addressed MS are located in the switching center database. For example, switching center 300 may search user's parameters 350 in the switching center database 340 for the required parameters of a specific MS. The user's parameters may be for example, arranged according to a user list wherein a user name, MS number or MS ID may be an entry and/or an address to the user's parameters. Other formats may be used.

Arrow 620 indicates that the specific user's parameters are located in the switching center database.

In block 630 a SC may send a message according to the user's parameters as were stored in a SC database to the MS. For example, a SC may send the message, for example, a promotion or greetings to a MS user according to his preferred parameters. For example, a MS user may choose to receive messages in a certain language, font or according to any other parameter.

Arrow 640 indicates that the specific user's parameters are not located in the switching center database.

In block 650 a SC may contact for example, the LSC database of the specific MS in order to retrieve MS user's parameters. Another entity may provide such parameters. For example, the MS may be roaming in a distant SC area. In such a scenario, the distant SC may contact the local SC of the MS in order to retrieve the MS user's parameters. In some embodiments of the present invention the distant SC may retrieve the user's parameters from another database, for example, the MSC database VDB or a VLR in which may contain the user's parameters of a roaming MS.

In block 660 a SC may send the message according to the user's parameters. For example, a SC may send the message, for example, a promotion or greetings to a MS user according to his preferred parameters.

Although the scope of the present invention is not limited in this respect, the SC may wish to send a message to a group of users, for example, a network operator may wish to send through the SC a promotion or a greeting message for a group of users, which may be located in a certain area. In some embodiments of the present invention the SC may send the message according to each user's parameters, for example, each MS user may get the same message content but in a different language, according to his preferred language, as may be saved in the SC database or may be transferred to SC from another SC or from MS.

Some embodiments of the present invention may be used to control WAP communications, for example, a user's parameters may be transferred to the a WAP server and users may receive alphanumeric information on their wireless terminals, for example, mobile stations, according to the user's parameters saved in a local or a distant server while roaming.

While certain features of the invention have been illustrated and described herein, many modifications, substitutions, changes, and equivalents will now occur to those skilled in the art. It is, therefore, to be understood that the appended claims are intended to covet all such modifications and changes as fall within the true spirit of the invention.

What is claimed is:

1. A method comprising:
storing a mobile station user's language parameters at a wireless communication system database; and
transferring messages to a mobile station according to the user's language parameters.

2. The method of claim 1 wherein the user's language parameters include an indication of a user's language

3. The method of claim 1 wherein the user's language parameters include an indication of a default language.

4. The method of claim 1 wherein the user's language parameters include an indication of a user's language font.

5. The method of claim 1 wherein the messages are transferred in a certain language according to a user's language parameters.

6. The method of claim 1 comprising displaying messages on a mobile station according to the user's language parameters.

7. The method of claim 1 comprising transferring a user's language parameters from one switching center to another switching center.

8. The method of claim 1 wherein storing a mobile station user's language parameters occurs when the mobile station user's language parameters are changed.

9. The method of claim 1 comprising transferring messages to a mobile station according to a user's language parameters when the mobile station is roaming.

10. A wireless communication system comprising:
a wireless communication system distant switching center comprising a database to store a mobile station user's language parameters and to receive a user's language parameters from a wireless communication system local switching center,
wherein the distant switching center is to transfer messages to a mobile station according to the stored user's language parameters.

11. The system of claim 10 wherein the mobile station's set of user's language parameters are changed by the user.

12. The system of claim 10 wherein the mobile station's set of user's language parameters is transferred to the local wireless communication system database.

13. The system of claim 10 wherein the user's language parameters include an indication of a user's language.

14. The system of claim 10 wherein the user's language parameters include an indication of a default language.

15. The system of claim 10 wherein the user's language parameters include an indication of a user's language font.

16. The system of claim 10 wherein the messages are transferred in a certain language according to user's language parameters.

17. The system of claim 10 wherein transferring messages to the mobile station from a distant area is according to the stored user's language parameters in the local wireless communication system database.

18. The system of claim 10 wherein the distant area wireless communication system switching center is to contact the local area wireless communication system database in order to use the stored user's language parameters for transferring messages to the mobile station.

19. A wireless communication system comprising:
a mobile station; and
a local switching center to transfer user's language parameters corresponding to the mobile station to a distant switching center,
wherein the distant switching center and the local switching center are to transfer messages to the mobile station according to the stored user's language parameters.

20. The system of claim 19 wherein the user's language parameters include a indication of a user's preferred language.

21. The system of claim 19 wherein the user's language parameters include a indication of a default language.

22. The system of claim 19 wherein the user's language parameters include a indication of a user's language font.

23. The system of claim 19 wherein transferring messages to the mobile station is according to the stored user's language parameters.

24. An article comprising:
a storage medium, having stored thereon instructions, that when executed, result in:
transferring messages to a mobile station of a wireless communication system according to a user's language parameters.

25. The article of claim 24, wherein the instructions that result in transferring messages comprise instructions that result in transferring a user's language parameters between switching centers.

26. The article of claim 24, wherein the instructions that result in transferring messages comprise instructions that result in transferring messages according to a user's preferred language.
